(19) United States
(12) Patent Application Publication
(10) Pub. No.: US 2006/0071789 A1
(43) Pub. Date: Apr. 6, 2006

(54) System and method for providing passenger security and convenience in a public transportation terminal

(75) Inventor: Demetri Giannopoulos, Norwalk, CT (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/537,617

(22) PCT Filed: Nov. 27, 2003
(86) PCT No.: PCT/IB03/05489

§ 371 Date: Jun. 3, 2005

(30) Foreign Application Priority Data
Dec. 6, 2002 (US) 60431451

(51) Int. Cl. G08B 13/14

(52) U.S. Cl. 340/572.1

(57) ABSTRACT

System and method for enhanced security and passenger convenience in a transportation terminal (10). Passengers carry an intelligent IEBP (53). The IEBP (53) is a portable electronic handset receiving optically transmitted positioning data and other information via artificial light sources (28) which optically transmit data (52), as well as provide conventional lighting. The IEBP devices (53) may guide passengers inside the terminal and inform them about delayed/missed flights or changes of schedule. To enhance security, the IEBP devices (53) track the location of passengers throughout the transportation terminal (10). The IEBP device (53) determines if the passenger is still carrying it and/or has entered an incorrect or unauthorized area The IEBP device (53) then generates a radio frequency signal (59) to a central monitoring station (56) warning appropriate authorities of the security violation, and may also indicate the violation to the passenger carrying the device.

### BACKGROUND OF THE INVENTION

1. Field of the Invention

This invention relates generally to security and in particular to a method and system for providing enhanced security and convenience to passengers while moving about a public transportation facility.

2. Description of Related Art

An identification badge is many times provided to employees of airports. Passengers however are usually identified only by a single photo identification that is presented at check-in. Security consists of a series of questions concerning baggage and tickets. No check is made on the identity of the passenger (except on international flights where a passport is requested). The passenger's location in the airport is not tracked. When the passenger checks into a flight, a boarding pass is presented and the passenger boards the aircraft. There is no verification that the same passenger who checked in is the one that boarded, and it is very easy for a boarded passenger to exit the aircraft after boarding without being noticed by anyone. Security at airports is minimal as to who a passenger is and where the passenger is in the airport.

Prior art systems have proposed electronic tickets and smart-cards that can be carried by passengers. Tuttle in U.S. Pat. No. 5,914,671 presents a system for locating an individual in a facility where a portable wireless transponder device is carried by the individual. Tuttle's device resembles a standard security badge with a possible photo of the individual on the badge. Tuttle's invention is directed toward location of employee's who would wear such badges. Tuttle states that a passenger could also possess such an identification and be located. However, Tuttle makes no reference to any type of security checking of the individual.

Yokozawa et al. in U.S. Pat. No. 5,740,369 present an information delivery system and portable information terminal where an individual possesses a smart-card type of wireless device and can be tracked by a wireless system. Yokozawa describes a person passing through a check-in gate with the gate itself recognizing and communicating with the portable device by wireless means. While Yokozama presents a wireless device carried by a passenger. There is no mention of the security aspects of the situation.

Sweatte in WO 02/27686 presents a method and system for airport security where passengers undergo positive identification (ID) by fingerprint scan, face scan or other suitable biometric technique for performing positive identification. The passenger is also given a wireless card that acts as a boarding pass. The person carries the card while in the airport The system is notified when the person enters a secure gate area, boards or leaves an aircraft While Sweatte presents a method and system for providing airport security. There is no mention of tracking the passenger at points other than entering the secure gate area or while boarding or leaving an aircraft.

The present invention overcomes the shortcomings of the prior art by providing an intelligent IEBP which encompasses enhanced security features as well as providing check-in conveniences to passengers while moving in and around a transportation terminal.

### SUMMARY OF THE INVENTION

The invention provides a system and method for providing enhanced security and check-in convenience for passengers in a public transportation facility.

In accordance with one aspect of the invention, a system for providing enhanced security and check-in convenience includes: a portable electronic handset carried by passengers, referred to as an intelligent IEBP (IEBP). The IEBP receives optically transmitted positioning data and passenger convenience data. The different data is downloaded to the IEBP from a central computer via a plurality of artificial light sources located throughout the transportation facility adapted to optically transmit the different data in addition to performing a conventional lighting function. The system further includes a central computer configured to control and coordinate the security and check-in convenience processes.

According to one aspect of the present invention, the IEBP provides information to passengers, communicated via optical means, pertaining to, for example, flight time arrivals and departures, delayed/missed flight arrangements, changes of flight schedule, and passenger guidance inside the transportation terminal.

According to another aspect of the invention, the IEBPs provide enhanced security in a system designed to track the location of passengers throughout a transportation terminal. Each IEBP is designed to receive optically transmitted positioning information at substantially periodic intervals from a plurality of local light sources designed to transmit such data. Upon receiving the positioning information, the IEBP determines whether the passenger carrying the device has entered an unauthorized area or the wrong departure gate. In this case, the IEBP may generate an audio and/or visual signal to the passenger indicating the security violation. Further, the IEBP will generate a radio frequency (RF) signal for transmission to a central monitoring station warming appropriate authorities of the security violation.

### BRIEF DESCRIPTION OF THE DRAWINGS

The foregoing features of the present invention will become more readily apparent and may be understood by referring to the following detailed description of an illustrative embodiment of the present invention, taken in conjunction with the accompanying drawings, where:

FIG. 1 is a plan view of a travel depot facility, such as an airport, including a system, embodying the invention; and

FIG. 2 illustrates a schematic view of a general layout of the communication system of the invention.

### DETAILED DESCRIPTION OF THE INVENTION

In the following detailed description of the present invention, numerous specific details are set forth in order to provide a thorough understanding of the present invention. However, it will be apparent to one skilled in the art that the present invention may be practiced without these specific details. In some instances, well-known structures and devices are shown in block diagram form, rather than in detail, in order to avoid obscuring the present invention.

In this disclosure, the term “transportation terminal”, is used to denote any common transportation terminal which serves to facilitate travel, and is intended to include, without limitation, plane terminals, bus terminals and train terminals. Also, the term “intelligent electronic boarding pass (IEBP)” is used to denote a handheld wireless device having capabilities for receiving and transmitting optical and radio frequency signals and having limited computational capabilities.

The intelligent IEBP is preferably carried or worn by passengers while moving about a public transportation terminal to enhance passenger/terminal security and provide check-in convenience features to the passengers. It will be immediately apparent however, that the intelligent IEBP (i.e., wireless device) finds useful application outside the mass transportation industry, and may find beneficial use wherever reliable identification and tracking of movable objects or persons is desired.

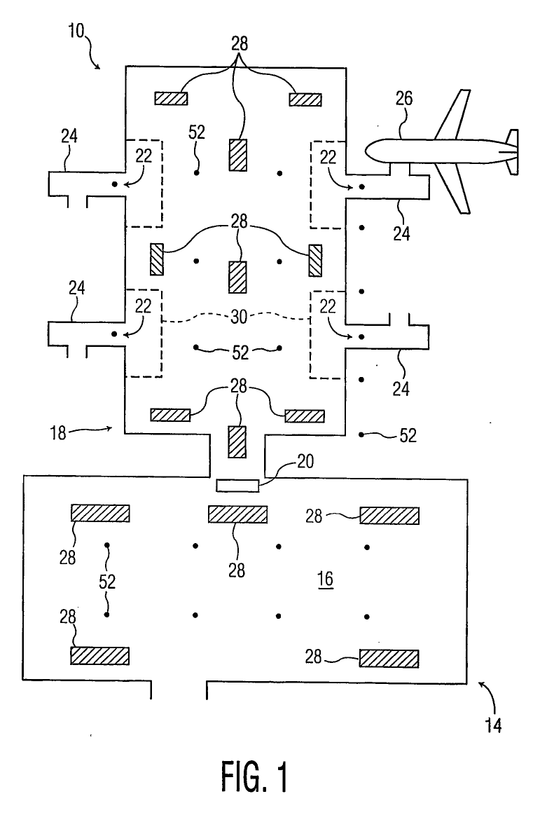

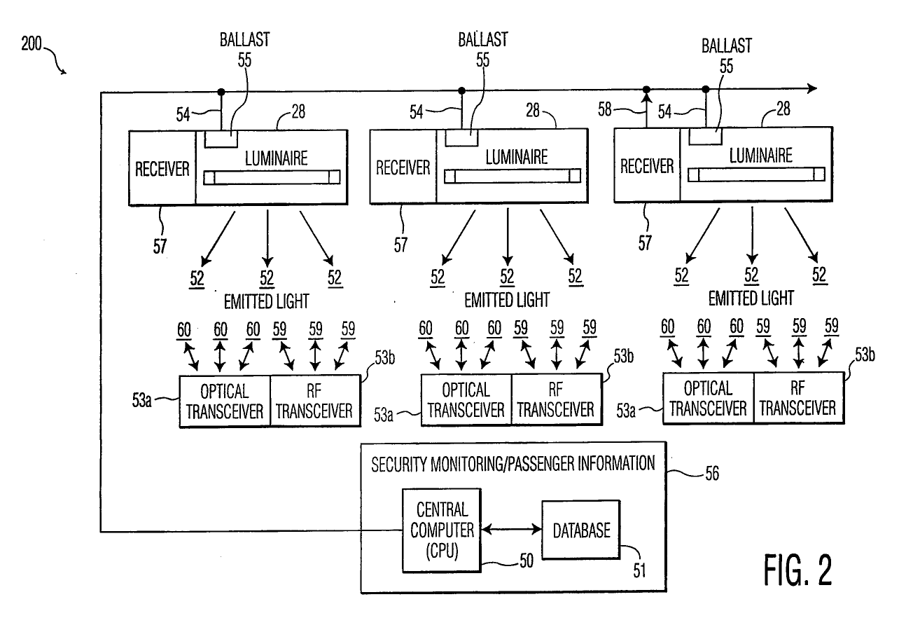

FIG. 1 shows a public transportation terminal 10, such as an airport, including the communication system 200 of the invention (see FIG. 2) for tracking passenger movement. The transportation terminal 10 includes various areas of a typical travel facility such as a main terminal area 14 which typically includes a baggage check in area 16, shops, restaurants, etc. The transportation terminal 10 further includes a terminal concourse area 18 which one enters after passing a check-in/check-out counter 20. The terminal concourse area 18 includes multiple gate doors 22 defining controlled access points. More particularly, the gate doors 22 are typically locked until a flight is available for departure or is being deplaned. Airline staff control passage through the gate doors and only permit people with boarding passes through the gate doors 22. The gate doors 22 lead to jet-ways 24 which are movable to define a path into an airplane. The terminal area 18 also includes multiple seating areas 30 which may be grouped off by gate. Both the main terminal area 14 and terminal concourse area 18 are illuminated by a fluorescent lighting system comprising a plurality of fluorescent lighting luminaries 28 which serve two functions. A primary function of providing illumination throughout the transportation terminal 10 and a secondary function of facilitating data transmission. Specifically, the fluorescent lighting luminaries 28 transmit data as a component of the system of the invention by modulating the light that is emitted from lamps in the fluorescent lighting fixtures 28 by various methods, including amplitude, frequency or phase modulation means within the ballast, with the data source being a central computer 50 (See FIG. 2). Such methods for transmitting data by light modulation techniques are well known in the art. One method for transmitting data via a fluorescent light ballast is described in U.S. Pat. No. 5,838,116, “Fluorescent Light Ballast with Information Transmission Circuitry”, issued to Katyl et al. on Nov. 17, 1998, incorporated by reference herein in its entirety

With reference now to FIG. 2, a general schematic layout of a communication arrangement 200, in accordance with the principles of this invention, is shown. The schematic layout uses a data link provided by the modulated, fluorescent lighting system 28 of FIG. 1. Also shown are three intelligent IEBPs 53 of the invention. The IEBPs 53 may be carried or worn by passengers moving about the terminal 10. Data from a source, such as the central computer 50, is connected to input data ports located on the ballasts 55 of a plurality of fluorescent lighting luminaries 28. The central computer 50 is associated with a security monitoring/passenger information entity 56. Emitted light (arrows 52) is modulated providing a way to transmit data from lamps in the fluorescent lighting luminaries 28. It is noted that if the type of modulation method utilized is frequency or phase modulation, the inclusion of data information into the light stream 52 at a sufficiently high frequency (e.g., on the order of lkHz or above) will not be noticeable by human viewers, as the typical frequencies used by electronic ballasts are greater than 25 kHz, significantly exceeding the response of human vision.

The IEBPs 53 include an optical transceiver 53a and a radio frequency (RF) transceiver 53b. The optical transceiver 53a is used to receive two types of data transmitted by the fluorescent lighting luminaries 28 via light output modulation, positioning data and passenger convenience data. The optical transceiver 53a is also used to implement a two-way, short distance high-speed communication between the IEBPs 53 and check-in/check-out devices 20 installed in the transportation terminal 10. The RF transceiver portion 53b, in a transmit mode, is used for notifying airport security personnel of suspected security violations or the disabling of an IEBP 53, intentional or otherwise. The RF transceiver portion 53b, in a receive mode, is used to receive RF signals designating a code change in the optically transmitted positioning data to thwart interception of the optical signal.

In an alternate embodiment, the code change designations may be implemented by synchronizing the IEBPs 53 at the airport check-in/check-out counter 20 with a valid code and a start time. After which, the IEBP 53 would use an internal clock and an algorithm stored in an internal memory to accept and interpret optically transmitted codes at later points in time. Thus, removing the need to transmit periodic RF code changes. In this case, the IEBP 53 would only need to include an RF transmitter.

The operation of the system and method of the invention is now described with reference to a non-limiting exemplary embodiment as shown in FIGS. 1 and 2.

Referring to FIGS. 1 and 2, in accordance with the exemplary embodiment, arriving and departing passengers are checked into and from flights at the check-in/check-out counter 20. At these counters 20 passengers queue up and wait to present their tickets and baggage. At this particular check-in/check-out point 20, an arriving passenger is required to present his or her picture, relevant personal information and ticket information which is entered into the airline database 51 by a security officer. This information becomes part of the official airline database 51. Once obtained, the passenger data is then encrypted and downloaded, via optical means, to an IEBP 53 of the invention issued to each passenger. Each passenger is required to carry the IEBP 53 with him or her while moving about the transportation terminal 10. Each passenger will be required to place his or her IEBP in a visible position (e.g., handheld or attached to an outer garment) so that security officers can spot individuals who do not display it visibly. The IEBP 53 of the invention may, in certain instances, substitute for a paper boarding pass for gaining entry onto an airplane. The IEBP 53, as described above, is a wireless device that can be tracked for location throughout the airport complex and provides passenger information.

Subsequent to being checked in, the passenger then may move about the transportation terminal 10 according to convention. However, while so doing, each issued IEBP 53 receives optically transmitted information from the lighting fixtures 28 as described above with reference to FIG. 2. The transmitted information is of two general types.

A first type of transmitted information from the lighting fixtures 28 to the IEBP 53 is directed to passenger convenience. This type of information may include, for example, information directed to delayed/missed flight arrangements, changes of flight schedule, and passenger guidance inside the transportation terminal, information on sales at the airport stores and personal messages. In the event of a flight schedule change, passengers would be required to verify such changes at a check-in/check-out device before the change becomes part of the official passenger database.

With reference again to FIG. 2, a second type of transmitted information from the lighting fixtures 28 to the IEBP 53 is directed to airport security and passenger safety. Each IEBP 53 receives optically transmitted positioning information (via optical transceiver 53a) from the fluorescent lighting fixtures 28 (arrows 52). Each IEBP 53 processes the received information, via computational means provided within each IEBP 53, to determine if the passenger has entered an unauthorized area or arrived at the wrong departure gate. In the event either of these two situations occur, or other security violation not explicitly recited herein, the IEBP will generate an audio and/or visual warning signal. Additionally, the IEBP 53 will transmit an RF signal (arrows 59) to the security monitoring/passenger information station 56 apprising the security monitoring/passenger information station 56 of the violation.

It is further contemplated by the invention that attempts will be made to thwart the enhanced security provided by the IEBP 53. Such attempts may include intentional disablement, or transmitting an identical optical signal from other than an authorized source. To prevent such occurrences, the optically transmitted positioning signal is periodically changed in accordance with an RF-transmitted signal received either from the fluorescent lighting luminaries 28 at a relatively low intensity, or from a centralized RF transmitter (not shown) at a higher intensity. The RF-transmitted signal could contain a code to be interpreted by referencing an internal algorithm stored in the IEBP 53. In this manner, if someone attempts to defeat the security system by transmitting an optical code from other than the authorized source, such attempts will be recognized by the IEBP 53 as a consequence of the illegally transmitted code not changing over time in accordance with the predetermined algorithm as is expected. The time interval for transmitting the RF signal could vary to suit the security needs of the facility.

As an alternative method for implementing optical code security, the IEBP 53 could be synchronized at the airport check-in/check-out counter 20 with a valid code and a start time. After which, the IEBP 53 would use an internal clock and an algorithm stored in an internal memory to accept and interpret optically transmitted codes at later points in time. Thus, removing the need to transmit periodic RF code changes.

It should be noted that the previous description of the preferred embodiments is provided to enable any person skilled in the art to make or use the present invention. The various modifications to these embodiments will be readily apparent to those skilled in the art, as well as other embodiments, without the use of the inventive faculty. Thus, the present invention is not intended to be limited to the embodiments shown herein but is to be accorded the widest scope consistent with the principles and novel features disclosed herein

1. A system for providing enhanced security and convenience for passengers in a public transportation terminal (10), comprising:
means for acquiring passenger data at check-in time;
means for entering said acquired passenger data into a database (51) associated with said public transportation terminal (10);
means for issuing said passenger a wireless device (53);
means for transferring said acquired passenger data from said database (51) to said issued wireless device (53);
means for optically transmitting positioning data and passenger convenience data to said issued wireless device (53); and
means for transmitting a radio frequency (RF) warning signal (59) from said issued wireless device (53) when a security violation is committed by said passenger.

2. The system of claim 1, further comprising means for generating one of an audible and/or visual security violation warning signal from said wireless device (53) when said passenger commits said security violation.

3. The system of claim 1, further comprising means for encoding said optically transmitted positioning data (60).

4. The system of claim 1, wherein said security violation is one of said passenger entering an unauthorized area and arriving at an incorrect terminal gate.

5. The system of claim 1, further comprising means for encrypting said acquired passenger data.

6. The system of claim 1, further comprising means for periodically changing a code for encoding said optically transmitted positioning data (60).

7. The system of claim 1, wherein said wireless device further includes means for detecting a change in said optically transmitted positioning data.

8. The system of claim 1, wherein said acquired passenger and travel data stored in said database (51) includes at least one positive passenger identification means, at least one item pertaining to passenger personal data and passenger ticket information.

9. A system for providing enhanced security and passenger convenience in a public transportation terminal (10), the system comprising:
(a) a central processor (50) associated with said terminal configured to:
1. generate positioning data;
2. generate passenger convenience data;
3. encode said positioning data; and
3. periodically implement a code change for encoding said positioning data;
(b) a plurality of data distribution lighting elements (28), coupled to said processor (50) and adapted to optically transmit said positioning and passenger convenience data from said processor throughout said public transportation terminal (10);
(c) a plurality of wireless devices (53), each device including an optical transceiver (53a) configured to receive said optically transmitted positioning and passenger convenience data (60) from said plurality of data distribution lighting elements (28) and a radio frequency (RF) transceiver (53b) configured to transmit an RF warning signal (59) in response to one of a malfunction in said wireless device (53) and a detection of a security violation committed by a passenger using said wireless device (53).

10. A method of providing security and passenger-convenience in a public transportation terminal (10), said method comprising the steps of:
acquiring passenger data at check-in time;
entering said acquired passenger data into a database (51) associated with said public transportation terminal (10);
issuing said passenger a wireless device (53) at said check-in time;
transferring said acquired passenger data from said database (51) to said passenger issued wireless device (53);
optically transmitting positioning data (60) and passenger convenience data (60) to said passenger issued wireless device (53);
generating an audio and/or visual signal when said passenger commits a security violation detectable by said passenger issued wireless device (53); and
transmitting a radio frequency (RF) warning signal (59) from said issued wireless device (53) when said wireless device (53) detects said security violation.

11. The method of claim 10, wherein said security violation is one of a passenger entering an unauthorized area or said passenger arriving at an incorrect terminal gate.

12. The method of claim 10, wherein said RF warning signal (59) is transmitted to a central security station (56).

13. The method of claim 10, wherein said wireless device (53) includes an optical RF transceiver (53a).

14. The method of claim 10, further comprising the step of encrypting said acquired passenger data (60) from said database (51).

15. The method of claim 10, wherein said passenger data acquired at check-in time includes at least one positive passenger identification means, passenger personal data and passenger ticket information.

16. The method of claim 10, wherein said passenger convenience data includes delayed or missed flight arrangements, changes of flight schedule and passenger guidance information.

17. The method of claim 10, further comprising the step of periodically changing a security code for transmitting the optically transmitted positioning data (60).
